(19) United States
(12) Patent Application Publication
(10) Pub. No.: US 2014/0247547 A1
(43) Pub. Date: Sep. 4, 2014

(54) PORTABLE TERMINAL HAVING A WIRELESS CHARGING MODULE

(71) Applicant: Samsung Electronics Co., Ltd., Gyeonggi-do (KR)

(72) Inventors: Hee-Won Jung, Gyeonggi-do (KR); Jun-Ho Koh, Suwon-si (KR)

(21) Appl. No.: 14/348,721

(22) PCT Filed: Sep. 20, 2012
(86) PCT No.: PCT/KR2012/007515

§ 371 Date: Mar. 31, 2014

(30) Foreign Application Priority Data
Sep. 30, 2011 (KR) 10-2011-0099866
Sep. 17, 2012 (KR) 10-2012-0102704

(51) Int. Cl. H02J 7/02

(52) U.S. Cl. CPC H02J 7/025
USPC 361/679.26

(57) ABSTRACT

A portable terminal is provided which includes a window member including a screen area and a bezel area enclosing the screen area; a display module arranged at an inner surface of the window member so as to output a screen through the screen area; and a receiving part resonant antenna arranged at the inner surface of the window member and attached to the bezel area, wherein the receiving part resonant antenna is arranged parallel to three sides of the display module.

### PRIORITY

This application is a National Phase Entry of PCT International Application No. PCT/KR2012/007515, which was filed Sep. 20, 2012, and claims priority to Korean Patent Application Nos. 10-2011-0099866 and 10-2012-0102704 filed Sep. 30, 2011 and Sep. 17, 2012, respectively, the entire contents of each of which are incorporated herein by reference.

### BACKGROUND

1. Field of the Invention

The present invention generally relates to a portable terminal including a cellular phone, a smartphone, or a tablet Personal Computer (PC), and more particularly, to a portable terminal including a wireless charging module.

2. Description of the Related Art

A portable terminal, i.e. a mobile communication terminal such as a cellular phone or a smartphone, has more and more functions due to the expansion of multimedia services. Also, as a variety of application programs are now provided, the functions of the portable terminal increase rapidly and variously, and a User Interface (UI) environment has been created to meet various tastes of users and provide convenience in use to the users.

Portable terminals may be classified into bar-type portable terminals, folder-type portable terminals, slide-type portable terminals, and swing-type portable terminals, depending on their appearances. When mobile communication such as voice communication and short text message transmission were primarily used, the folder-type terminals or the slide-type terminals occupied most of the portable terminal market. However, as the multimedia services have increased, the need for extended display devices is increasing. Thus, as the display device of the portable terminal has been extended, a touchscreen function is now provided on the display device to remove a physical keypad from the portable terminal. That is, the physical keypad is removed by mounting a touchscreen display device on the portable terminal, thereby reducing the thickness of the portable terminal for portability while extending the display device.

Moreover, the portable terminal is provided with antenna devices enabling communication in various frequency bands, such as a Digital Multimedia Broadcasting (DMB) antenna, a Local Area Network (LAN) antenna, a Near Field Communication (NFC) antenna, a Bluetooth antenna, and so forth, as well as an antenna device for a mobile communication function. Recently, an antenna and a module for providing a wireless charging function as well as the foregoing antenna devices have been mounted on the portable terminal

FIG. 1 is an exploded perspective view illustrating a portable terminal 100 according to the conventional art, in which the portable terminal 100 includes a wireless charging module having a receiver resonant antenna 131 that provides a wireless charging function and a reception circuit unit provided on a board 133.

As illustrated in FIG. 1, the terminal 100 includes a battery mounting groove 119 formed on a back surface of a main body 101 and a camera module 117 provided near the battery mounting groove 119. The battery mounting groove 119 is hidden by a cover member 102 removably provided on the back surface of the main body 101, and a user may remove the cover member 102 to access the battery mounting groove 119 when necessary. The cover member 102 includes an opening 127 for exposing the camera module 117 to allow the camera module 117 to photograph a subject when the cover member 102 is coupled to the main body 101.

A wireless charging module is provided in an inner side of the cover member 102. The wireless charging module includes the receiver resonant antenna 131 and the reception circuit unit. To provide a stable installation structure for the receiver resonant antenna 131 and the reception circuit unit, a second cover member 141 may be further provided in the inner side of the cover member 102.

The receiver resonant antenna 131 generates signal power based on magnetic induction or magnetic resonance according to an electromagnetic field formed in a primary coil of a charger (not illustrated), and delivers the generated signal power to the reception circuit unit. A connection piece 131a connected to the reception circuit unit is formed at a side of the receiver resonant antenna 131. The receiver resonant antenna 131 is attached to the inner side of the cover member 102. However, in the portable terminal 100 illustrated in FIG. 1, the second cover member 141 is coupled to the cover member 102 in a state where the receiver resonant antenna 131 is attached to the inner side of the second cover member 141. Thus, the receiver resonant antenna 131 is disposed between the inner side of the cover member 102 and the inner side of the second cover member 141.

To prevent the electromagnetic field formed around the receiver resonant antenna 131 from affecting internal circuit devices or a battery pack of the main body 102, the terminal 100 includes an electromagnetic shielding member 139. The electromagnetic shielding member 139 is attached on the cover member 102, and is disposed between the receiver resonant antenna 131 and the main body 102. Since the receiver resonant antenna 131 is attached directly to the second cover member 141 as mentioned before, the electromagnetic shielding member 139 is first attached to the second cover member 141 and then the receiver resonant antenna 131 is attached on the electromagnetic shielding member 139.

The reception circuit unit includes a wireless charging circuit provided on the board 133 to convert the signal power received via the receiver resonant antenna 131 into charging power and provide the charging power to the battery pack mounted in the terminal main body 101. A connection unit 13 lb corresponding to the connection piece 131a is provided at a side of the board 133. The reception circuit unit, together with the receiver resonant antenna 131, is also attached to the second cover member 141. When the receiver resonant antenna 131 and the reception circuit unit are attached to the second cover member 141, the connection piece 131a and the connection unit 131b are engaged and thus electrically connected with each other.

A flexible printed circuit 135 is disposed at a side of the reception circuit unit, and a connection pad 137 is provided in an end portion of the flexible printed circuit 135. The charging power provided from the reception circuit unit is delivered to the main body 101 through the flexible printed circuit 135 and the connection pad 137. The main body 101 includes a connection terminal 115, and when the cover member 102 is coupled to the main body 101, the connection pad 137 is connected with the connection terminal 115 to provide the charging power to the main body 101, and more specifically, to the battery pack mounted in the battery mounting groove 119 on the main body 101.

FIG. 2 schematically illustrates a structure of the wireless charging module disposed on the cover member 102. FIG. 2 is intended to show a height h, that is, a thickness of the wireless charging module, and it should be noted that the second cover member 141 is not shown and the wireless charging module is attached directly to the cover member 102.

The receiver resonant antenna 131 and the electromagnetic shielding member 139 are deposited in the inner side of the cover member 102, and the reception circuit unit includes circuit elements 133a, such as a charging control circuit chip or an inductor, disposed on the board 133. The thickness of the receiver resonant antenna 131 and the board 133 is approximately 0.35 mm, and the thickness of the electromagnetic shielding member 139 is about 0.6 mm, and the maximum height of the circuit elements 133a is about 1.25 mm. Thus, the thickness of the wireless charging module reaches a maximum of 1.6 mm in the inner side of the cover member 102.

The display device providing multimedia functions of the portable terminal has been emphasized, and much effort has been made to reduce the thickness and weight of the portable terminal for portability. In this situation, the wireless charging module makes it convenient to charge the portable terminal, although it is accompanied by an increase in the thickness of the portable terminal. In particular, since portable terminals having thicknesses of 10 mm or less have become more popular due to the tendency toward slimness of the portable terminals, mounting a wireless charging module having a thickness of 1.6 mm hinders slimness of the portable terminals.

Moreover, when the receiver resonant antenna or the reception circuit unit is disposed to face the battery pack, the thickness of the portable terminal may be further increased. Since the battery pack is rectangular and requires a predetermined volume, the thickness of the portable terminal is inevitably increased to accommodate a space for receiving the receiver resonant antenna when the receiver resonant antenna is disposed facing the battery pack.

### SUMMARY

The present invention has been made to address at least the above-mentioned problems and/or disadvantages and to provide at least the advantages described below. Accordingly, an aspect of the present invention is to provide a portable terminal that has mounted thereon a wireless charging module including an additional antenna, in particular, a receiver resonant antenna, thereby improving convenience in use.

Another aspect of the present invention is to provide a portable terminal that suppresses an increase in thickness in spite of having mounted thereon a wireless charging module, thereby making it easy to insure portability.

In accordance with an aspect of the present invention, there is provided a portable terminal including a window member comprising a screen area and a bezel area enclosing the screen area, a display module disposed in an inner side of the window member to output a screen through the screen area, and a receiver resonant antenna attached to the bezel area in the inner side of the window member, in which the receiver resonant antenna is disposed in parallel with at least three sides of the display module.

In accordance with another aspect of the present invention, there is provided a portable terminal including a main body, a window member mounted on a front surface of the main body, a display module disposed in an inner side of the window member to output a screen, and a receiver resonant antenna attached to the inner side of the window member in a circumference of the display module, in which the receiver resonant antenna is disposed in parallel with a side of the display module.

### BRIEF DESCRIPTION OF THE DRAWINGS

The above and other aspects, features, and advantages of the present invention will be more apparent from the following detailed description taken in conjunction with the accompanying drawings, in which:

FIG. 1 is an exploded perspective view illustrating a portable terminal according to the conventional art;

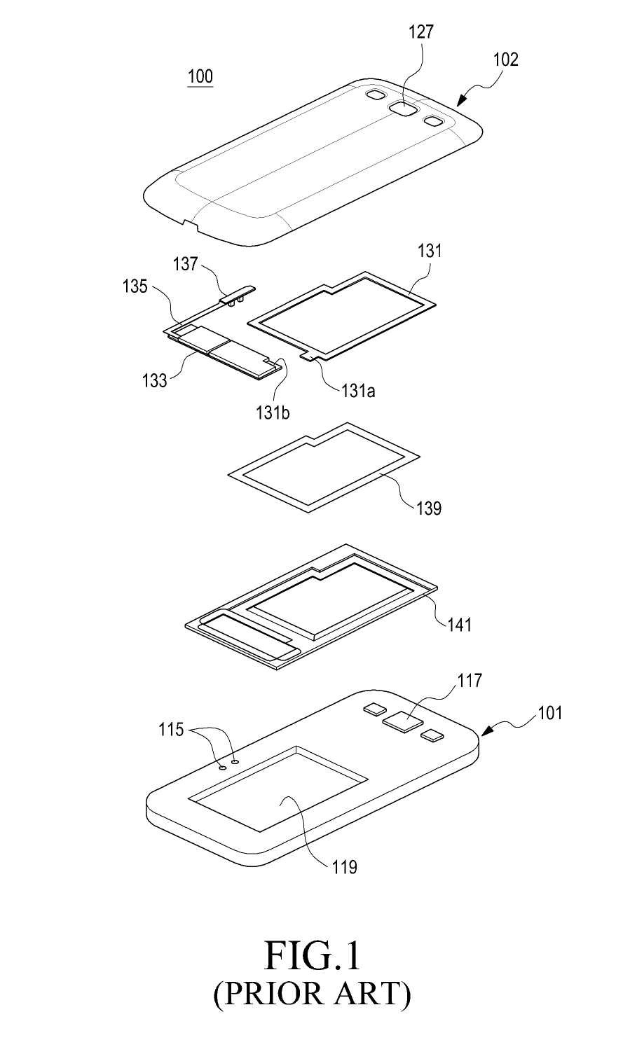

FIG. 2 is a structural diagram illustrating a wireless charging module of a portable terminal illustrated in FIG. 1;

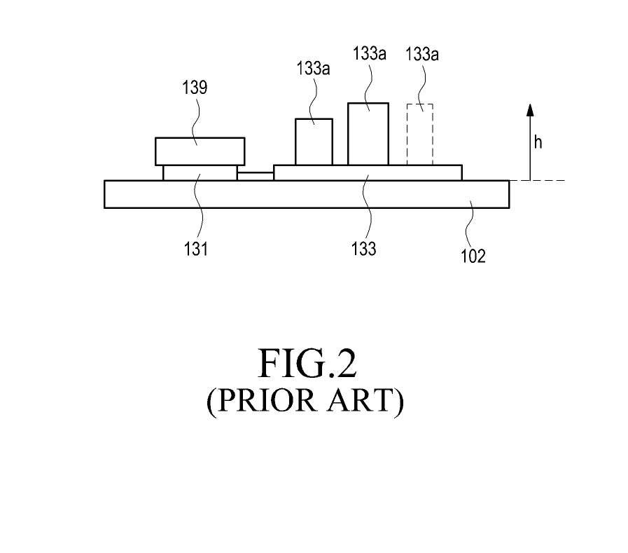

FIG. 3 is an exploded perspective view illustrating a portable terminal according to an embodiment of the present invention; and

FIG. 4 is a cross-sectional diagram cut through a part of a portable terminal illustrated in FIG. 3.

### DETAILED DESCRIPTION OF EMBODIMENTS OF THE PRESENT INVENTION

Hereinafter, an embodiment of the present invention will now be described in detail with reference to the accompanying drawings. In describing the present invention, a detailed description of known functions or structures determined to unnecessarily obscure the subject matter of the present invention will be omitted.

The portable terminal as described herein uses a bezel area provided around a display device on a front surface and an internal space of a main body corresponding to the bezel area when a receiver resonant antenna is disposed in the portable terminal. Thus, without substantially increasing the thickness of the portable terminal, an additional communication function, for example, a wireless charging function may be easily provided on the portable terminal.

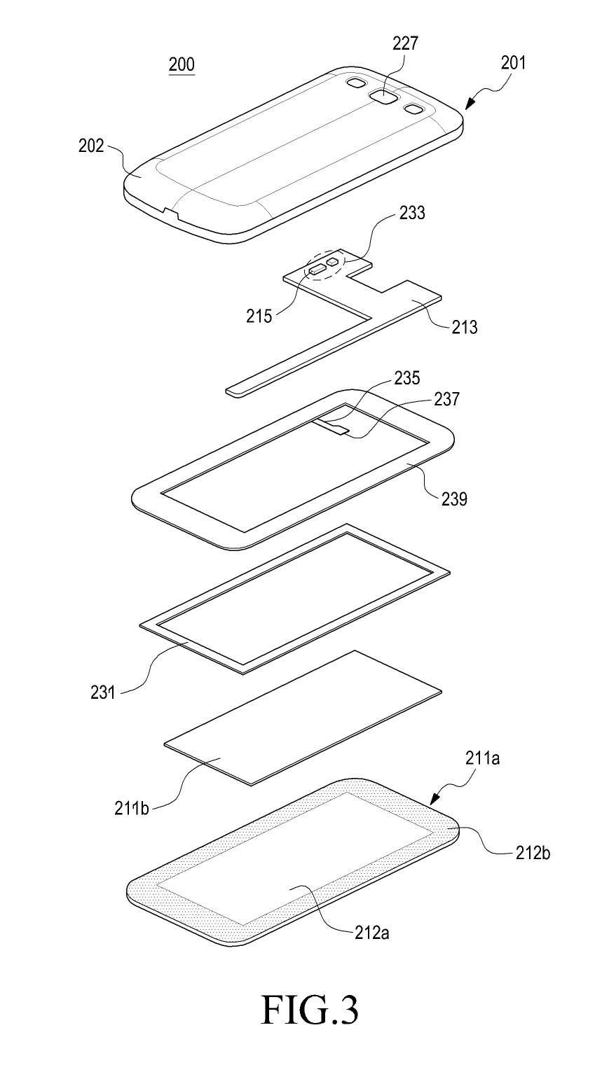

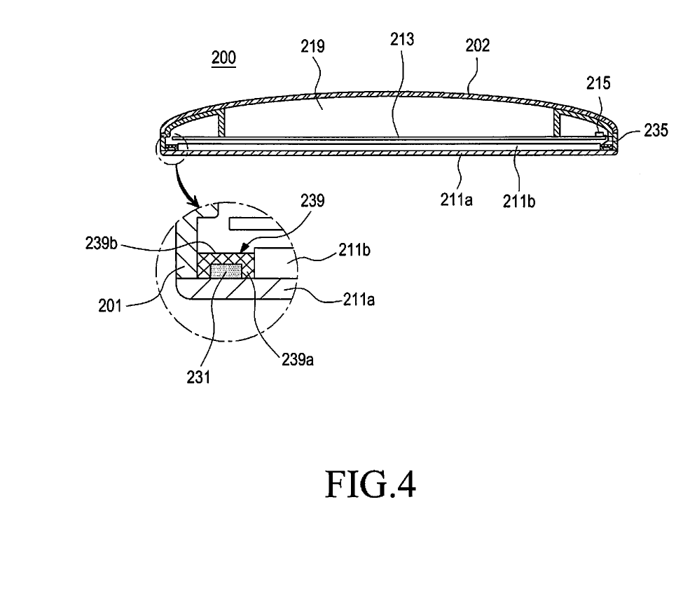

FIG. 3 is an exploded perspective view illustrating a portable terminal 200 according to an embodiment of the present invention, and FIG. 4 is a cross-sectional diagram taken from a part of the terminal 200 illustrated in FIG. 3.

As illustrated in FIGS. 3 and 4, the portable terminal 200 according to an embodiment of the present invention includes a display module 211b, a window member 211a coupled to a front surface of the display module 211b, and a receiver resonant antenna 231 attached to an inner side of the window member 211a about a circumference of the display module 211b. The receiver resonant antenna 231 may be disposed parallel to at least three of four sides of the display module 211b. In a detailed embodiment of the present invention, the receiver resonant antenna 231 is disposed to enclose the four sides of the display module 211b.

A main body 201 of the terminal 200 includes a battery mounting groove 219 (illustrated in FIG. 4) formed on a back surface, and the battery mounting groove 219 is hidden by a separate cover member 202. In the main body 201, a camera module 227 is installed which is exposed to outside through an opening formed in the cover member 202. In the main body 201, a main circuit board 213 is received on which various circuit devices, a connector, and a socket 215 are mounted. The main circuit board 213 is disposed in an inner side of the display module 211b. The circuit devices disposed on the main circuit board 213 include a circuit connected to the receiver resonant antenna 231, for example, a reception circuit unit 233.

The window member 211a is coupled to a front surface of the main body 201 in a state where the display module 211b is received in the main body 201. The window member 211a may be divided into a screen area 212a and a bezel area 212b. The screen area 212a faces the display module 211b and provides a screen implemented with the display module 211b. The bezel area 212b provides an area for coupling, more specifically, attaching or adhering the window member 211a to the main body 201, and prevents an inner side of the main body 201 from being exposed to the outside.

The receiver resonant antenna 231 is a type of a receiver (RX) resonator, and generates signal power based on magnetic induction or magnetic resonance according to an electromagnetic field generated in a primary coil of a charger (not illustrated) and delivers the generated signal power to the reception circuit unit 233. The receiver resonant antenna 231 may be in the form of a flat plate or a film that may be attached to the inner side, more specifically, to the bezel area 212b of the window member 211a, and may have various patterns by using a copper plate or a conductive material such as silver or gold. The reception circuit unit 233 includes a wireless charging circuit having a circuit element such as a charging control circuit chip or an inductor to convert the signal power provided from the receiver resonant antenna 231 into charging power to charge the battery pack coupled to the battery mounting groove 219.

A flexible printed circuit board 235 is provided at a side of the receiver resonant antenna 231, and a connector 237 is provided at an end portion of the flexible printed circuit board 235. The connector 237 is connected to the socket 215 installed on the main circuit board 213 to connect the receiver resonant antenna 231 to the reception circuit unit 233, and more specifically, to the charging control circuit chip of the reception circuit unit 233. That is, the receiver resonant antenna 231 is connected to the reception circuit unit 233 via the flexible printed circuit board 235 and the connector 237.

The receiver resonant antenna 231 may be disposed parallel to the display module 211b or the at least three sides of the display module 211b to enclose the four sides of the display module 211b. That is, when the back surface of the main body 201 is illustrated as a plan view, the receiver resonant antenna 231 is shown disposed about the circumference of the display module 211b, and as illustrated in FIG. 4, if the main body 201 is illustrated as a side view or a cross-sectional view, the receiver resonant antenna 231 is shown disposed parallel to the display module 211b.

The receiver resonant antenna 231 generates significant electromagnetic waves as a result of operating based on magnetic induction or magnetic resonance. Thus, to prevent the electromagnetic waves from affecting the battery pack coupled to the main body 201 or the internal circuit devices of the main body 201, for example, a circuit of the main circuit board 213, the terminal 200 includes an electromagnetic shielding member 239. The electromagnetic shielding member 239, as best seen in FIG. 4, is disposed between the receiver resonant antenna 231 and the circuit devices received in the internal space of the main body 201, and between the receiver resonant antenna 231 and the display module 211b.

More specifically, the electromagnetic shielding member 239 includes a first shielding unit 239a provided between the display module 211b and the receiver resonant antenna 231 and a second shielding unit 239b that extends from the first shielding unit 239a and is disposed between the receiver resonant antenna 231 and the circuit device, and more specifically, the main circuit board 213. Thus, the first shielding unit 239a is attached to a sidewall of the display module 211b. The second shielding unit 239b is also attached to the inner side of the window member 211a, while enclosing the receiver resonant antenna 231. Hence, as illustrated in FIG. 4, in a detailed embodiment of the present invention, the electromagnetic shielding member 239 has a generally n-shaped groove and is provided for enclosing the receiver resonant antenna 231 except for a part facing the front surface of the main body 201.

The reception circuit unit 233 includes the charging control circuit chip to convert the signal power provided from the receiver resonant antenna 231 to the charging power, as described above. In other words, the receiver resonant antenna 231 and the reception circuit unit 233 form the wireless charging module. The reception circuit unit 233 may be disposed on a board provided separately from the main circuit board 213, but in a detailed embodiment of the present invention, the reception circuit unit 233 includes the circuit devices such as the charging control circuit chip or the inductor disposed on the main circuit board 213.

As described above, the receiver resonant antenna and the electromagnetic shielding member of the portable terminal according to the present invention are received in the internal space of the main body of the portable terminal corresponding to the bezel area of the window member, and thus do not substantially affect the thickness of the portable terminal. That is, as mentioned above, the conventional wireless charging module including the receiver resonant antenna and the reception circuit unit, when mounted on the portable terminal, increases the thickness of the portable terminal by a maximum of 1.6 mm, but the wireless charging module according to the present invention makes it convenient to use the portable terminal through the wireless charging function without substantially increasing the thickness of the portable terminal.

While the present invention has been particularly shown and described with reference to an embodiment thereof, it will be understood by those of ordinary skill in the art that various changes in form and details may be made therein without departing from the scope of the present invention.

1-13. (canceled)

14. A portable terminal comprising:
a window member comprising a screen area and a bezel area enclosing the screen area;
a display module disposed on an inner side of the window member to allow a screen to be viewed through the screen area; and
a receiver resonant antenna attached to the bezel area on the inner side of the window member,
wherein the receiver resonant antenna is disposed parallel to at least three sides of the display module.

15. The portable terminal of claim 14, further comprising an electromagnetic shielding member attached to the bezel area and disposed at least between the display module and the receiver resonant antenna.

16. The portable terminal of claim 15, wherein the electromagnetic shielding member comprises:
a first shielding unit disposed between the display module and the receiver resonant antenna; and
a second shielding unit that extends from the first shielding unit and is disposed between circuit devices received in an internal space of the terminal and the receiver resonant antenna.

17. The portable terminal of claim 16, further comprising a main circuit board disposed on an inner side of the display module,
wherein the circuit devices are provided on the main circuit board.

18. The portable terminal of claim 16, wherein the circuit devices comprise a charging control circuit chip.

19. The portable terminal of claim 16, further comprising:
a flexible printed circuit board extending from the receiver resonant antenna; and
a connector provided in an end portion of the flexible printed circuit board.

20. The portable terminal of claim 16, wherein the circuit devices comprise a charging control circuit chip and the receiver resonant antenna is connected to the charging control circuit chip.

21. The portable terminal of claim 14, wherein the receiver resonant antenna is disposed to enclose four sides of the display module.

22. A portable terminal comprising:
a main body;
a window member mounted on a front surface of the main body;
a display module disposed on an inner side of the window member to allow a screen to be viewed; and
a receiver resonant antenna attached to the inner side of the window member about a circumference of the display module,
wherein the receiver resonant antenna is disposed parallel to a side of the display module.

23. The portable terminal of claim 22, further comprising:
a main circuit board provided inside the main body; and
an electromagnetic shielding member attached to the window member,
wherein the electromagnetic shielding member comprises a first shielding unit disposed between the display module and the receiver resonant antenna and a second shielding unit that extends from the first shielding unit and is disposed between the receiver resonant antenna and the main circuit board.

24. The portable terminal of claim 23, wherein the main circuit board comprises a charging control circuit chip and the receiver resonant antenna is connected to the charging control circuit chip.

25. The portable terminal of claim 24, further comprising:
a flexible printed circuit board extending from the receiver resonant antenna; and
a connector provided in an end portion of the flexible printed circuit board,
wherein the receiver resonant antenna is connected to the charging control circuit chip via the flexible printed circuit board and the connector.

26. The portable terminal of claim 22, wherein the receiver resonant antenna is disposed to enclose four sides of the display module.

27. A portable terminal comprising:
a window member comprising a screen area;
a display module disposed on an inner side of the window member to allow a screen of the display module to be viewed through the screen area of the window member;
a receiver resonant antenna attached to an inner side of the window member; and
an electromagnetic shielding member having a U-shaped groove to accommodate the receiver resonant antenna.
